(19) United States
(12) Patent Application Publication
(10) Pub. No.: US 2017/0256038 A1
(43) Pub. Date: Sep. 7, 2017

(54) Image Generating Method and Apparatus, and Image Analyzing Method

(71) Applicant: Vuno Korea, Inc., Seoul (KR)

(72) Inventors: Yeha LEE, Hwaseong-si, Gyeonggi-do (KR); Hyun-Jun KIM, Yongin-si, Gyeonggi-do (KR); Kyuhwan JUNG, Seoul (KR); Sangki KIM, Seoul (KR)

(21) Appl. No.: 14/787,728

(22) PCT Filed: Sep. 24, 2015
(86) PCT No.: PCT/KR2015/010085

§ 371 Date: Oct. 28, 2015

(51) Int. Cl. G06T 5/00

(52) U.S. Cl. CPC G06T 5/005; G06T 2207/20084; G06T 2207/20081

(57) ABSTRACT

An image generating method and apparatus, and an image analyzing method are disclosed. The image generating method includes receiving a reference image, and generating a training image from the reference image by adding noise to at least one parameter of a window width and a window level of pixel values of the reference image.

### PRIORITY CLAIM

This application is a National Stage of International Application PCT/KR/2015/010085 filed on Sep. 24, 2015. The entirety of the International Application is hereby incorporated by reference.

### FIELD

The following description relates to an image generating method and apparatus and an image analyzing method, and more particularly, to a method and an apparatus for generating a training image to be used for training a neural network and to a method of analyzing an input image using the neural network trained based on the generated training image.

### BACKGROUND

Recently, research has been actively conducted on methods of applying an effective pattern recognition method performed by human beings to computers, as a solution to classify an input pattern as a group. One of these methods relates to an artificial neural network obtained by modeling a characteristic of human biological neurons through a mathematical expression. The artificial neural network uses an algorithm emulating a learning ability of human beings to classify an input pattern as a group. Through such an algorithm, the artificial neural network generates a mapping between the input pattern and output patterns, which indicates a learning ability of the artificial neural network. In addition, the artificial neural network possesses a generalizing ability to generate a relatively correct output in response to an input pattern that is not used for training based on a result of the training.

Such an artificial neural network includes a relatively large number of layers, and thus a great amount of training data may be required to train the artificial neural network in such a large structure including the numerous layers and the artificial neural network may be required not to overfit certain training data.

### SUMMARY

According to an aspect of the present invention, there is provided an image generating method including receiving a reference image, and generating a training image from the reference image by adding noise to at least one parameter of a window width and a window level of pixel values of the reference image.

When a remaining parameter between the window width and the window level to which the noise is not added exists, the generating of the training image may include generating the training image from the reference image based on the parameter to which the noise is added and the remaining parameter to which the noise is not added.

The window width and the window level may include a preset value for an object to be analyzed by a neural network to be trained based on the training image.

The window width indicates a range of pixel values to be included in the training image among the pixel values of the reference image.

The window level indicates a center of the range of the pixel values to be included in the training image.

The reference image may be a medical image obtained by capturing the object to be analyzed by the neural network to be trained based on the training image.

The generating of the training image may include changing a value of the at least one parameter of the window width and the window level to allow the window width and the window level to deviate from a preset value for the object to be analyzed by the neural network to be trained based on the training image.

The image generating method may further include adding noise to a pixel value of the training image.

The noise to be added to the pixel value of the training image may be generated based on at least one of a characteristic of a device capturing the reference image and an object included in the reference image.

According to another aspect of the present invention, there is provided an image analyzing method including receiving an input image and analyzing the input image based on a neural network. The neural network may be trained based on a training image extracted from a reference image, and the training image may be generated from the reference image by adding noise to at least one parameter of a window width and a window level of pixel values of the reference image.

According to still another aspect of the present invention, there is provided an image generating apparatus including a memory in which an image generating method is stored and a processor configured to execute the image generating method. The processor may generate a training image from a reference image by adding noise to at least one parameter of a window width and a window level of pixel values of the reference image.

According to an embodiment, by adding noise to a parameter to be used when extracting a training image from a reference image, a training image to which natural noise is applied may be obtained, a training effect for a neural network to be trained may be enhanced, and the neural network may become more robust against various changes.

According to an embodiment, by adding noise to at least one parameter of a window width and a window level to be used when extracting a training image from a reference image, effective modifications may be made to a training image to be used to train a neural network, and an amount of the training image may greatly increase.

### DRAWINGS

FIG. 1 is a flowchart illustrating an example of an image generating method according to an embodiment.

FIG. 2 is a diagram illustrating an example of a window width and a window level according to an embodiment.

FIG. 3 is a diagram illustrating an example of a window width to which noise is added according to an embodiment.

FIG. 4 is a diagram illustrating an example of a window level to which noise is added according to an embodiment.

FIG. 5 is a diagram illustrating an example of a window width and a window level to which noise is added according to an embodiment.

FIG. 6 is a flowchart illustrating another example of an image generating method according to another embodiment

FIG. 7 is a diagram illustrating an example of an image generating apparatus according to an embodiment.

FIG. 8 is a diagram illustrating an example of an image analyzing method according to an embodiment.

### DETAILED DESCRIPTION

Hereinafter, examples are described in detail with reference to the accompanying drawings. The following specific structural or functional descriptions are provided to merely describe the examples, and the scope of the examples is not limited to the descriptions provided in the present specification. Various changes and modifications can be made thereto by those of ordinary skill in the art. Like reference numerals in the drawings denote like elements, and a known function or configuration will be omitted herein.

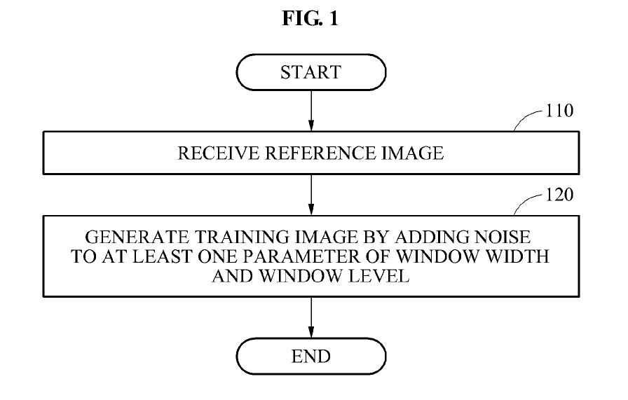

FIG. 1 is a flowchart illustrating an example of an image generating method according to an embodiment.

The image generating method may be performed by a processor included in an image generating apparatus. The image generating apparatus may be widely used in a field of generating training data, for example, a training image, to train a neural network configured to analyze, for example, recognize, classify, and detect, an input image. The neural network is a recognition model provided in a form of software or hardware that emulates a calculation ability of a biological system using numerous artificial neurons connected through connection lines.

The neural network may include a plurality of layers. For example, the neural network may include an input layer, a hidden layer, and an output layer. The input layer may receive an input for training, for example, training data, and transfer the input to the hidden layer, and the output layer may generate an output of the neural network based on a signal received from nodes of the hidden layer. The hidden layer may be disposed between the input layer and the output layer, and change the training data transferred through the input layer to a predictable value.

The neural network may include a plurality of hidden layers. The neural network including the hidden layers is referred to as a deep neural network, and training the deep neural network is referred to as deep learning.

A training image generated by the image generating apparatus may be input to a neural network to be trained. Here, the image generating apparatus may make various modifications to data to be input to the neural network by applying random noise to the training image. Through such data modifications, a great amount of training images may be generated to train the neural network, and thus the neural network may not overfit a certain training image and may become more robust against noise. Hereinafter, a process of generating a training image using random noise by the image generating apparatus will be described.

Referring to FIG. 1, in operation 110, the image generating apparatus receives a reference image. The image generating apparatus receives the reference image from an externally located device through an embedded sensor or a network.

The reference image is a medical image obtained by capturing an object, for example, a bone, an organ, and blood, to be analyzed by the neural network, and may include pixels having a value of 12 bit. Since a general display device may express 8 bit pixel value, while the reference image includes the 12 bit pixel value, the reference image may not be displayed on the display device. Thus, to visualize such a medical image on the display device, converting the reference image of 12 bit to an image of 8 bit or less may be necessary.

Thus, the image generating apparatus may convert the reference image to a visible image by restricting a range of a pixel value of the reference image to be displayed on the display device and determining a center of the range of the pixel value to be expressed. Here, the range of the pixel value to be expressed is referred to as a window width, and the center of the range of the pixel value to be expressed is referred to as a window level.

In operation 120, the image generating apparatus generates a training image from the reference image by adding noise to at least one parameter of the window width and the window level of pixel values of the reference image.

The image generating apparatus adds the noise to the at least one parameter of the window width and the window level of the pixel values of the reference image. Here, the window width and the window level indicate parameters used to generate the training image from the reference image by the image generating apparatus.

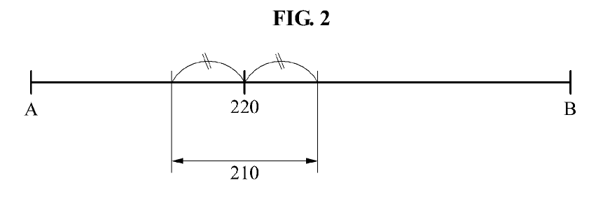

The image generating apparatus adds the noise to the at least one parameter of the window width and the window level. For example, the image generating apparatus may add the noise to both the window width and the window level. Alternatively, the image generating apparatus may add the noise to any one of the window width and the window level. The adding of the noise to the at least one parameter of the window width and the window level will be described in detail with reference to FIGS. 2 through 5.

For example, when the noise is added to both the window width and the window level, the image generating apparatus may generate the training image from the reference image based on the parameter to which the noise is added. Here, the parameter to which the noise is added may be the window width and the window level.

For another example, when the noise is added to any one of the window width and the window level, the image generating apparatus may generate the training image from the reference image based on the parameter to which the noise is added and a remaining parameter to which the noise is not added. That is, in the presence of the remaining parameter between the window width and the window level to which the noise is not added, the image generating apparatus may generate the training image from the reference image based on the parameter and the remaining parameter. Here, the parameter indicates a parameter between the window width and the window level to which the noise is added, and the remaining parameter indicates the other parameter between the window width and the window level to which the noise is not added.

FIG. 2 is a diagram illustrating an example of a window width and a window level according to an embodiment.

In FIG. 2, a window width 210 and a window level 220 of a pixel value of a reference image are illustrated. The reference image is a medical image obtained by capturing an object to be analyzed by a neural network, and may include an image obtained by capturing through various methods, for example, a magnetic resonance imaging (MRI), a computed tomography (CT), an x-ray, and a positron emission tomography (PET).

Dissimilar to a general image, the reference image may be a gray-scale image and have a pixel value of 12 bit. A pixel included in the reference image may have an approximately 4000-level value, which deviates from a range, for example, 8 bit, expressed by a pixel of the general image.

The reference image may include a Hounsfield unit (HU) value. An HU scale indicates a degree of absorption in a body based on a difference in density of tissues through which an x-ray is transmitted. An HU may be obtained by setting water as 0 HU, a bone as 1000 HU, and air having a lowest absorption rate as −1000 HU, and calculating a relative linear attenuation coefficient based on relative x-ray absorption of each tissue. The HU may also be referred to as a CT number.

Referring to FIG. 2, A indicates −1000 HU which is a minimum HU value that may be possessed by the reference image, and B indicates +3000 HU which is a maximum HU value that may be possessed by the reference image.

A human eye may not recognize all pixel values of 12 bit included in the reference image. Thus, the reference image may need to be converted to an image of 8 bit that is recognizable by the human eye. For the conversion, an HU range to be expressed in the reference image may be restricted and a center of the HU range to be expressed may be determined. The HU range is indicated by the window width 210 and the center of the HU range is indicated by the window level 220.

The window width 210 and the window level 220 may be determined in advance based on the object to be analyzed by the neural network. For example, when the object to be analyzed by the neural network is an abdominal soft tissue, the window width 210 may be determined to be 350 to 400 HU and the window level 220 may be determined to be 50 HU. For another example, when the object to be analyzed by the neural network is lung, the window width 210 may be determined to be 1500 to 1600 HU and the window level 220 may be determined to be −700 HU. Here, a detailed value of the window width 210 and the window level 220 may be set as an HU value to be input from a user or an HU value determined by receiving N points for the object to be analyzed from the user.

According to an embodiment, an image generating apparatus may add noise to at least one parameter of the window width 210 and the window level 220, and generate a training image from the reference image using the parameter to which the noise is added. Thus, the image generating apparatus may generate various training images to train the neural network, and the neural network may become more robust against noise without overfitting a certain training image by being trained based on the various training images.

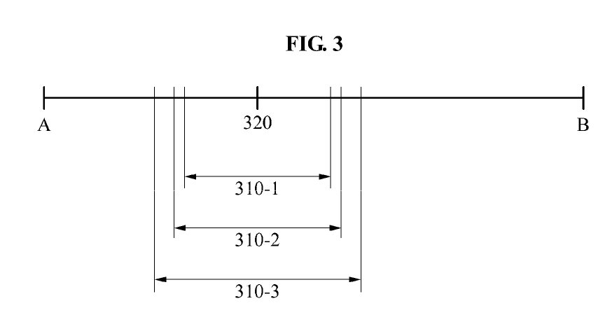

FIG. 3 is a diagram illustrating an example of a window width to which noise is added according to an embodiment.

In FIG. 3, a window width, for example, a first window width 310-1, a second window width 310-2, and a third window width 310-3, to which noise is added by an image generating apparatus is illustrated. The illustrated window widths 310-1, 310-2, and 310-3 to which the noise is added may have various ranges, and a window level 320 to which noise is not added may have a single value.

Referring to FIG. 3, the first window width 310-1 has a smaller range than the second window width 310-2 and the third window width 310-3. A training image extracted through the first window width 310-1 and the window level 320 may have a smaller range of expressible pixel values than a training image extracted using the second window width 310-2 or the third window width 310-3. Conversely, a training image extracted through the third window width 310-3 and the window level 320 may have a wider range of expressible pixel values than a training image extracted using the first window width 310-1 or the second window width 310-2.

For example, when an object to be analyzed by a neural network to be trained is a bone and noise of a minimum magnitude is added to the second window width 310-2, a training image extracted through the second widow width 310-2 may more clearly indicate the bone than a training image extracted using the first window width 310-1 or the third window width 310-3. The training image extracted through the first window width 310-1 may include a portion of the bone, in lieu of an entire bone, and the training image extracted through the third window width 310-3 may include another portion of a body in addition to the bone.

The image generating apparatus may generate a training image to which natural noise is applied by extracting the training images through the various window widths 310-1 through 310-3 to which noise is added.

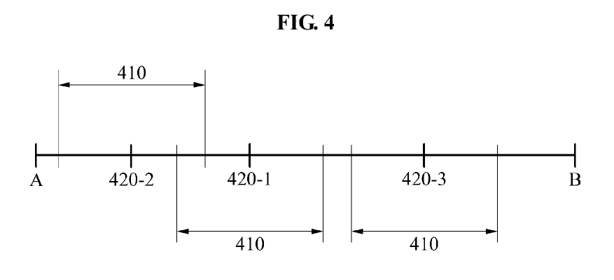

FIG. 4 is a diagram illustrating an example of a window level to which noise is added according to an embodiment.

In FIG. 4, a window level, for example, a first window level 420-1, a second window level 420-2, and a third window level 420-3, to which noise is added by an image generating apparatus is illustrated. The illustrated window levels 420-1, 420-2, and 420-3 to which the noise is applied by the image generating apparatus may have various values, and a window width 410 to which noise is not added may have ranges of a same magnitude.

Referring to FIG. 4, the first window level 420-1 has a value greater than a value of the second window level 420-2 and smaller than a value of the third window level 420-3. The second window level 420-2 has the value smaller than the value of the first window level 420-1, and the third window level 420-3 has the value greater than the value of the first window level 420-1.

For example, since a training image extracted from a reference image using the first window level 420-1 and a training image extracted from the reference image using the second window level 420-2 share a portion of an HU range, the extracted training images may have a shared portion to be expressed. However, since a training image extracted using the third window level 420-3 and the training image extracted using the first window level 420-1 or the second window level 420-2 do not share a portion of an HU range, the extracted training images may not have a shared portion to be expressed.

The image generating apparatus may generate a training image to which natural noise is applied by extracting the training image using the various window levels 420-1, 420-2, and 420-3 to which noise is added.

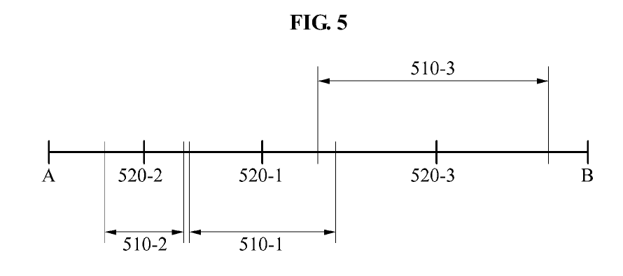

FIG. 5 is a diagram illustrating an example of a window width and a window level to which noise is added according to an embodiment.

In FIG. 5, a window width, for example, a first window width 510-1, a second window width 510-2, and a third window width 510-3, and a window level, for example, a first window level 520-1, a second window level 520-2, and a third window level 520-3, to which noise is added by an image generating apparatus are illustrated. The illustrated window widths 510-1, 510-2, and 510-3 to which the noise is added may have various ranges, and the illustrated window levels 520-1, 520-2, and 520-3 to which the noise is added may have various values.

Referring to FIG. 5, the window widths 510-1, 510-2, and 510-3 have respective ranges increasing in order of the second window width 510-2, the first window width 510-1, and the third window width 510-3, and the window levels 520-1, 520-2, and 520-3 have respective values increasing in order of the second window level 520-2, the first window level 520-1, and the third window level 520-3.

For example, a training image extracted through the first window width 510-1 and the first window level 520-1 and a training data extracted through the second window width 510-2 and the second window level 520-2 may not have a shared portion to be expressed. However, the training image extracted through the first window width 510-1 and the first window level 520-1 and a training image extracted through the third window width 510-3 and the third window level 520-3 may have a shared portion to be expressed.

The image generating apparatus may generate a training image to which natural noise is applied by extracting the training images through the various window widths 510-1, 510-2, and 510-3 and the various window levels 520-1, 520-2, and 520-3 to which noise is added.

Various modifications may be made to the example of adding noise to at least one parameter of a window width and a window level, which is described with reference to FIGS. 3 through 5, based on a design.

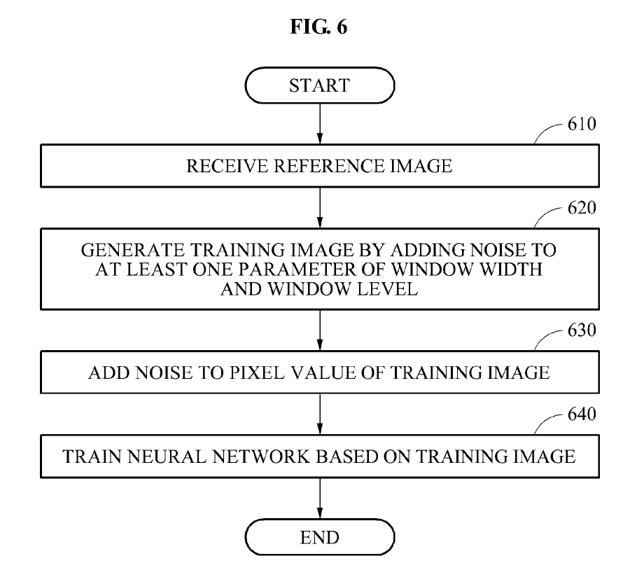

FIG. 6 is a flowchart illustrating another example of an image generating method according to another embodiment.

The image generating method may be performed by a processor included in an image generating apparatus.

Referring to FIG. 6, in operation 610, the image generating apparatus receives a reference image. The reference image is a medical image obtained by capturing an object, for example, a bone, an organ, and blood, to be analyzed by a neural network and may include pixels having a value of 12 bit.

In operation 620, the image generating apparatus generates a training image from the reference image by adding noise to at least one parameter of a window width and a window level of pixel values of the reference image. Here, the window width and the window level indicate parameters used when generating the training image from the reference image by the image generating apparatus.

The image generating apparatus generates the training image from the reference image using the parameter to which the noise is added. For example, when the noise is added to both the window width and the window level, the image generating apparatus may extract the training image from the reference image based on the parameter to which the noise is added. Here, the parameter to which the noise is added is the window width and the window level.

For another example, when the noise is added to any one of the window width and the window level, the image generating apparatus may extract the training image from the reference image based on the parameter to which the noise is added and a remaining parameter to which the noise is not added. That is, in the presence of the remaining parameter between the window width and the window level to which the noise is not added, the image generating apparatus may generate the training image from the reference image based on the parameter and the remaining parameter.

In operation 630, the image generating apparatus adds noise to a pixel value of the training image. The training image generated in operation 620 is an image generated from the reference image using the parameter to which the noise is added, and thus the noise may not be added to the pixel value. The image generating apparatus may thus additionally add random noise to the pixel value of the training image generated in operation 620.

The image generating apparatus may generate a noise pattern based on a characteristic of a device capturing the reference image, and add the generated noise pattern to the pixel value of the training image. For example, the image generating apparatus may identify the device based on information about the device capturing the reference image, and generate the noise pattern based on the identified device. Here, the device capturing the reference image may be a medical device capturing an object using various methods, for example, an MRI, a CT, an X-ray, and a PET, and the characteristic of the device may include information about a manufacturer of the device.

In addition, the image generating apparatus may generate a noise pattern based on an object included in the reference image, and add the generated noise pattern to the pixel value of the training image. For example, the image generating apparatus may generate the noise pattern based on whether the object included in the reference image is a bone, an organ, blood, or a tumor. Further, the image generating apparatus may generate the noise pattern based on a shape of the bone, the organ, the blood, or the tumor.

In operation 640, the image generating apparatus trains the neural network based on the training image. Here, the training image is an image extracted from the reference image using the parameter to which the noise is added, and may include the noise in the pixel value.

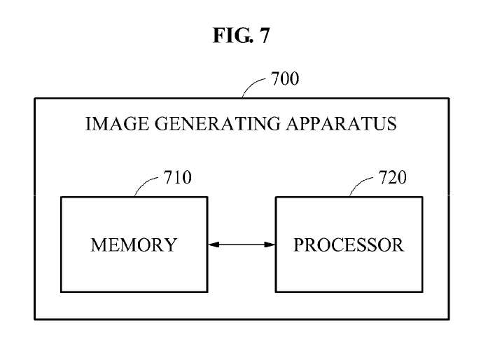

FIG. 7 is a diagram illustrating an example of an image generating apparatus according to an embodiment.

Referring to FIG. 7, an image generating apparatus 700 includes a memory 710 and a processor 720. The image generating apparatus 700 may be widely used in a field of generating training data, for example, a training image, to train a neural network configured to analyze, for example, recognize, classify, and detect, an input image. The image generating apparatus 700 may be included in various computing devices and/or systems, for example, a smartphone, a tablet personal computer (PC), a laptop computer, a desktop computer, a television (TV), a wearable device, a security system, and a smart home system.

The memory 710 stores an image generating method. The image generating method stored in the memory 710 relates to a method of generating the training image to train the neural network, and may be executed by the processor 720. In addition, the memory 710 stores a training image generated in the processor 720, or stores the neural network trained based on the generated training image.

The processor 720 executes the image generating method. The processor 720 adds noise to at least one parameter of a window width and a window level of pixel values of a reference image. Here, the window width and the window level indicate parameters used for the processor 720 to generate the training image from the reference image.

The processor 720 generates the training image from the reference image using the parameter to which the noise is added. For example, when the noise is added to both the window width and the window level, the processor 720 may extract the training image from the reference image based on the parameter to which the noise is added. Here, the parameter to which the noise is added indicates the window width and the window level.

For another example, when the noise is added to any one parameter of the window width and the window level, the processor 720 may extract the training image from the reference image based on the parameter to which the noise is added and a remaining parameter to which the noise is not added. That is, in the presence of the remaining parameter between the window width and the window level to which the noise is not added, the processor 720 may generate the training image from the reference image based on the parameter and the remaining parameter.

When noise is not additionally added to a pixel value of the training image, the processor 720 may store the training image extracted from the reference image in the memory 710, or store the neural network trained based on the extracted training image in the memory 710.

When noise is additionally added to the pixel value of the training image, the processor 720 may add the noise to the pixel value of the training image based on at least one of a characteristic of a device capturing the reference image and an object included in the reference image.

The processor 720 generates a noise pattern based on the characteristic of the device capturing the reference image, and adds the generated noise pattern to the pixel value of the training image. For example, the processor 720 may identify the device based on information about the device capturing the reference image, and generate the noise pattern based on the identified device.

In addition, the processor 720 generates a noise pattern based on the object included in the reference image, and adds the generated noise pattern to the pixel value of the training image. For example, the processor 720 may generate the noise pattern based on whether the object included in the reference image is a bone, an organ, blood, or a tumor. Further, the processor 720 may generate the noise pattern based on a shape of the bone, the organ, the blood, or the tumor.

The processor 720 stores the generated training image in the memory 710.

Further, the processor 720 trains the neural network based on the training image. Here, the training image is an image extracted from the reference image using the parameter to which the noise is added, and may include noise in the pixel value.

The processor 720 stores the trained neural network in the memory 710. For example, the processor 720 may store, in the memory 710, parameters associated with the trained neural network.

The details described with reference to FIGS. 1 through 6 may be applicable to a detailed configuration of the image generating apparatus 700 illustrated in FIG. 7, and thus more detailed and repeated descriptions will be omitted here.

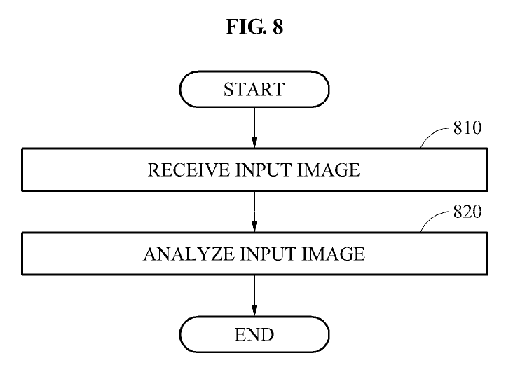

FIG. 8 is a diagram illustrating an example of an image analyzing method according to an embodiment.

The image analyzing method may be performed by a processor included in an image analyzing apparatus.

Referring to FIG. 8, in operation 810, the image analyzing apparatus receives an input image. The input image may be a medical image including an object, for example, a bone, an organ, and blood, to be analyzed. The image analyzing apparatus may receive the input image from an externally located device through an embedded sensor or a network.

In operation 820, the image analyzing apparatus analyzes the input image based on a neural network. The neural network is a trained neural network, and may be trained based on a training image extracted from a reference image.

The training image may be generated from the reference image by adding noise to at least one parameter of a window width and a window level of pixel values of the reference image.

The image analyzing apparatus may classify the input image using the neural network. For example, the image analyzing apparatus may classify the input image including the object as a disease based on the neural network, and verify a progress of the disease. For another example, the image analyzing apparatus may detect a lesion included in the input image using the neural network. Here, the neural network may be trained based on various medical images including such a lesion.

The details described with reference to FIGS. 1 through 7 may be applicable to a process of generating a training image used to train a neural network, and thus more detailed and repeated descriptions will be omitted here.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An image generating method, comprising:
receiving a reference image; and
generating a training image from the reference image by adding noise to at least one parameter of a window width and a window level of pixel values of the reference image.

2. The method of claim 1, wherein, in the presence of a remaining parameter between the window width and the window level to which the noise is not added, the generating of the training image comprises:
generating the training image from the reference image based on the parameter to which the noise is added and the remaining parameter to which the noise is not added.

3. The method of claim 1, wherein the window width and the window level comprises a preset value for an object to be analyzed by a neural network to be trained based on the training image.

4. The method of claim 1, wherein the window width indicates a range of pixel values to be comprised in the training image among the pixel values of the reference image.

5. The method of claim 1, wherein the window level indicates a center of a range of the pixel values to be comprised in the training image.

6. The method of claim 1, wherein the reference image is a medical image obtained by capturing an object to be analyzed by a neural network to be trained based on the training image.

7. The method of claim 1, wherein the generating of the training image comprises:
changing a value of the at least one parameter of the window width and the window level to allow the window width and the window level to deviate from a preset value for an object to be analyzed by a neural network to be trained based on the training image.

8. The method of claim 1, further comprising:
adding noise to a pixel value of the training image.

9. The method of claim 8, wherein the noise to be added to the pixel value of the training image is generated based on at least one of a characteristic of a device capturing the reference image and an object comprised in the reference image.

10. An image analyzing method, comprising:
receiving an input image; and
analyzing the input image based on a neural network, and
wherein the neural network is trained based on a training image extracted from a reference image, and
wherein the training image is generated from the reference image by adding noise to at least one parameter of a window width and a window level of pixel values of the reference image.

11. An image generating apparatus, comprising:
a memory in which an image generating method is stored; and
a processor configured to execute the image generating method, and
wherein the processor is configured to generate a training image from a reference image by adding noise to at least one parameter of a window width and a window level of pixel values of the reference image.

12. The apparatus of claim 11, wherein, in the presence of a remaining parameter between the window width and the window level to which the noise is not added, the processor is configured to generate the training image from the reference image based on the parameter to which the noise is added and the remaining parameter to which the noise is not added.

13. The apparatus of claim 11, wherein the window width and the window level comprise a preset value for an object to be analyzed by a neural network to be trained based on the training image.

14. The apparatus of claim 11, wherein the window width indicates a range of pixel values to be comprised in the training image among the pixel values of the reference image.

15. The apparatus of claim 11, wherein the window level indicates a center of ti. 4 range of the pixel values to be comprised in the training image.

16. The apparatus of claim 11, wherein the reference image is a medical image obtained by capturing an object to be analyzed by a neural network to be trained based on the training image.

17. The apparatus of claim 11, wherein the processor is configured to change a value of the at least one parameter of the window width and the window level to allow the window width and the window level to deviate from a preset value for an object to be analyzed by a neural network to be trained based on the training image.

18. The apparatus of claim 11, wherein the processor is configured to add noise to a pixel value of the training image.

19. The apparatus of claim 18, wherein the noise to be added to the pixel value of the training image is generated based on at least one of a characteristic of a device capturing the reference image and an object comprised in the reference image.
